(19) United States
(12) Patent Application Publication
(10) Pub. No.: US 2010/0187932 A1
(43) Pub. Date: Jul. 29, 2010

(54) DISC DRIVING DEVICE AND METHOD FOR MANUFACTURING THE SAME

(76) Inventors: Noboru Kawai, Tottori (JP); Toshiyuki Nishikata, Osaka (JP)

Correspondence Address: RATNERPRESTIA, P.O. BOX 980, VALLEY FORGE, PA, 19482, US

(21) Appl. No.: 12/676,972

(22) PCT Filed: Oct. 9, 2008
(86) PCT No.: PCT/JP2008/002852

§ 371 Date: Mar. 8, 2010

(30) Foreign Application Priority Data
Oct. 15, 2007 (JP) 2007-267602

(51) Int. Cl. H02K 1/28; H02K 15/03

(52) U.S. Cl. 310/156.12; 29/598

(57) ABSTRACT

A disc driving device includes a rotor assembly including a cylindrical rotor frame, a magnet arranged inside the rotor frame concentrically therewith so as to form a cylindrical space, a shaft fixed at one end thereof with the center hole of the shaft holder formed at the rotation center of the rotor frame, and a bearing for supporting the rotor assembly. The center hole of the shaft holder includes a small-diameter portion at the bottom thereof in the axial direction of the shaft, and an inclined portion which is formed above the small-diameter portion in such a manner as to be tapered and expanded upward in the axial direction. The shaft holder and the shaft have a void therebetween, which is filled with ultraviolet curing adhesive so as to form an adhesive fastening portion.

### TECHNICAL FIELD

The present invention relates to a disc driving device for motor-driving a rotor frame thereof on which to place an optical disc medium such as a CD or a DVD, and also to a method for manufacturing the disc driving device.

### BACKGROUND ART

In recent years, disc driving devices for driving optical disc media such as, CDs and DVDs have been increasingly used in personal portable devices, and it has been strongly desired to reduce the cost of the disc driving devices and to increase their reliability. At the same time, the disc driving devices have been required to have more precise mechanical characteristics with increasing size of information to be recorded in media and with increasing speed to read information therefrom.

To meet this request, with a purpose of achieving low-cost production, for example, motors used in disc driving devices has a large number of pressed parts. Such pressed parts contribute to the low cost production, but some have lower processing accuracy than conventionally used cutting parts. Therefore, in order to achieve a disc driving device having precise mechanical characteristics, it is essential to provide a method of assembly or an assembly jig that does not depend on processing accuracy.

One of the key elements for disc driving devices to have precise mechanical characteristics such as low surface runout of the turntable is a technique for fastening between the rotor frame and the shaft of the motor. A popular method for fastening between the rotor frame and the shaft is adhesive fastening. In adhesive fastening, the key things are the fastening strength and the assembly accuracy obtained after adhesive fastening is completed, and the productivity during the adhesive fastening process.

Regarding the assembly accuracy, which is one of the key things, it has been proposed to adhesively fasten a rotor frame and a shaft, and to assemble them accurately using ultraviolet curing adhesive (see, for example, Patent Literature 1). In this case, there is provided an adhesive receiving space between a rotor frame and the rotating shaft in the center hole of the rotor frame. Ultraviolet curing adhesive is injected into the adhesive receiving space and cured while a turntable including the rotor frame is being rotated. According to this approach, the rotor frame, which is rotated by the rotating shaft, can be fastened to the shaft horizontally or substantially horizontally. In addition, the amount of surface runout of the rotor frame can be set within a predetermined range.

There have been proposed disc driving devices manufactured by a combination of press fitting and adhesive fastening (see, for example, Patent Literature 2). Such a disc driving device includes a spindle motor, and a spindle as a shaft having a circumferential groove. The spindle motor is formed by injecting adhesive into the circumferential groove, pressing a rotor frame onto the spindle, and then fastening the rotor frame onto the spindle. The combination of press fitting and adhesive fastening is said to reduce the surface runout of the rotor frame and to improve the productivity and the reliability of the disc driving devices.

As another example of the combination of press fitting and adhesive fastening, it has been proposed to perform fastening work by using a projecting annular portion formed in the rotor frame (see, for example, Patent Literature 3). The rotor frame has a projecting annular portion at its center, and the projecting annular portion is provided on its inner diameter side with a small-inner-diameter portion and a large-inner-diameter portion. According to this approach, adhesive is applied to these inner-diameter portions first, and then the rotor frame is pressed and then fastened onto the shaft.

In the conventional technique of Patent Literature 1 described above, ultraviolet curing adhesive is cured while the rotor frame is being rotated, possibly causing the components to be fastened in the adhesive fastening portion to move before the adhesive is completely cured. This creates a problem in terms of the reliability of the strength of the adhesive fastening portion.

In the conventional techniques of Patent Literatures 2 and 3 described above, adhesive fastening in the state that the rotor frame is loosely fitted onto the shaft without applying unnecessary stress can be achieved using cutting parts which are precisely processed, and cannot be well achieved using pressed parts. Thus, applying too much stress to the shaft causes a decrease in mechanical reliability or in assembly accuracy due to an increasing range of surface runout, although the strength of the adhesive fastening portion is secured.

Patent Literature 1: Japanese Patent Unexamined Publication No. 2001-332014

Patent Literature 2: Japanese Patent Unexamined Publication No. 2000-134894

Patent Literature 3: Japanese Patent Unexamined Publication No. 2002-136031

### SUMMARY OF THE INVENTION

The disc driving device of the present invention includes a rotor assembly and a bearing for supporting the rotor assembly. The rotor assembly includes a cylindrical rotor frame, a magnet arranged inside the rotor frame concentrically therewith so as to form a cylindrical space, and a shaft fixed at one end thereof with the center hole of a shaft holder formed at the rotation center of the rotor frame. The center hole of the shaft holder includes a small-diameter portion at the bottom thereof in the axial direction of the shaft, and an inclined portion above the small-diameter portion, the inclined portion being tapered and expanded upward in the axial direction. The shaft holder and the shaft have a void therebetween which is filled with ultraviolet curing adhesive so as to form an adhesive fastening portion.

The method for manufacturing a disc driving device of the present invention includes fixing a shaft in such a manner that the lower end of the shaft comes into contact with the bottom-surface-of-shaft-fixing-section of a shaft fixing section of a rotor assembly jig; sliding the center hole of a shaft holder formed at the rotation center of a cylindrical rotor frame onto the shaft, thereby vertically sliding the rotor frame onto the shaft; injecting ultraviolet curing adhesive from above into a void formed between the shaft holder and the shaft; adhesively fixing the rotor frame to the shaft by applying ultraviolet light from above the void, thereby curing the ultraviolet curing adhesive; heat curing the ultraviolet curing adhesive injected in the void between the shaft holder and the shaft in a heating device; placing a lid on the top of the shaft; and attaching a rotor assembly to a bearing of a stator assembly. After the injecting step and before the adhesively fixing step, a predetermined time is waited until the ultraviolet curing adhesive is completely injected into a small-diameter portion formed in the center hole of the shaft holder and an inclined portion formed above the small-diameter portion in such a manner as to be tapered and expanded upward in an axial direction.

When structured and manufactured as described above, the disc driving device of the present invention has, in spite of its small size, an extremely low surface runout of its rotor frame mounting surface, and high adhesion reliability of the adhesive fastening portion in which the shaft holder of the rotor frame and the shaft are adhesively fastened

### BRIEF DESCRIPTION OF THE DRAWINGS

FIG. 1A is a schematic sectional view of a disc driving device according to a first exemplary embodiment of the present invention, and more specifically, a sectional view of the disc driving device including a rotor assembly in which adhesively fastening has been completed.

FIG. 1B is a schematic sectional view of the disc driving device, and more specifically, an enlarged sectional view of a part “A”, which is the adhesive fastening portion shown in FIG. 1A.

FIG. 1C is a schematic sectional view of the disc driving device, and more specifically, an enlarged sectional view of a modified example of the part “A”, which is the adhesive fastening portion shown in FIG. 1A.

FIG. 2 shows the relationship between surface runout and shear strength as fastening strength with respect to clearance X.

FIG. 3 shows the relationship between the time required for the ultraviolet curing adhesive to be cured by ultraviolet irradiation and shear strength.

FIG. 4 shows a process flow for manufacturing a disc driving device according to the first exemplary embodiment of the present invention.

FIG. 5A is a sectional view showing a shaft fixation step S1 of the method for manufacturing the disc driving device of the first exemplary embodiment of the present invention.

FIG. 5B is a sectional view showing a sliding step S2 of the method for manufacturing the disc driving device.

FIG. 5C is a sectional view showing an injection step S3 of the method for manufacturing the disc driving device.

FIG. 5D is a sectional view showing an adhesive fixation step S4 of the method for manufacturing the disc driving device.

FIG. 6A is a sectional view showing a heat curing step S5

FIG. 6B is a sectional view showing a placement step S6 of the method for manufacturing the disc driving device.

FIG. 6C is a sectional view showing a rotor assembly attachment step S7 of the method for manufacturing the disc driving device.

FIG. 7A is a schematic sectional view of a rotor frame of a disc driving device according to a second exemplary embodiment of the present invention, and more specifically, a sectional view of a rotor assembly mounted on a rotor assembly jig.

FIG. 7B is an enlarged plan view of an essential part of the rotor assembly that is in a dotted line region “B” shown in FIG. 7A when viewed from the direction of an arrow “C”.

FIG. 7C is an enlarged plan view of a modified example of the essential part of the rotor assembly that is in the dotted line region “B” shown in FIG. 7A when viewed from the direction of the arrow “C”.

FIG. 8A is a schematic view of an assembly jig which can be used to assemble the rotor assembly in the first and second exemplary embodiments of the present invention, and more specifically, a plan view of the rotor assembly jig.

FIG. 8B is a schematic view of the assembly jig, and more specifically, a perspective view of an essential part of a shaft fixing section at the center of the rotor assembly jig.

REFERENCE MARKS IN THE DRAWINGS

| | |
|---|---|
| 1 | disc driving device |
| 1a | base |
| 1b | stator core |
| 2 | rotor frame |
| 2a | top-surface-of-rotor-frame |
| 2b | the direction of arrow |
| 2c | rotor frame mounting portion |
| 2d | rotor frame mounting surface |
| 3 | magnet |
| 4 | shaft holder |
| 5 | center hole |
| 6 | shaft |
| 6a | upper end surface |
| 7, 27 | rotor assembly |
| 7a | turntable |
| 8 | bearing |
| 8a | bearing hole |
| 9 | small-diameter portion |
| 10 | inclined portion |
| 11 | void |
| 12 | ultraviolet curing adhesive |
| 13, 13a | adhesive fastening portion |
| 13b | strength reinforcing portion |
| 14 | stator assembly |
| 15 | lower void |
| 17 | rotor assembly jig |
| 17a | rotor frame mounting surface |
| 18, 29 | shaft fixing section |
| 18a | shaft-upper-part position control section |
| 18b | shaft-lower-part position control section |
| 18c | bottom-surface-of-shaft-fixing-section |
| 19 | nozzle |
| 20 | connector |
| 21 | syringe |
| 22 | ultraviolet irradiation head |
| 23 | heating atmosphere |
| 24 | lid |
| 28 | assembly jig |
| 31 | shaft-center-part position control jig |
| 32 | shaft-upper-part position control section |
| 33 | notch groove (guide groove) |
| 34 | shaft-lower-part position control section |
| 35 | shaft-center-part position control section |
| 40 | penetrating portion |

### DETAILED DESCRIPTION OF PREFERRED EMBODIMENTS

Exemplary embodiments of the present invention will be described as follows with reference to drawings. In the second embodiment, like components are labeled with like reference numerals with respect to the first embodiment, and the description thereof may be omitted. The drawings are only schematic, and the shapes of the components are often inaccurately illustrated for easier understanding.

### First Exemplary Embodiment

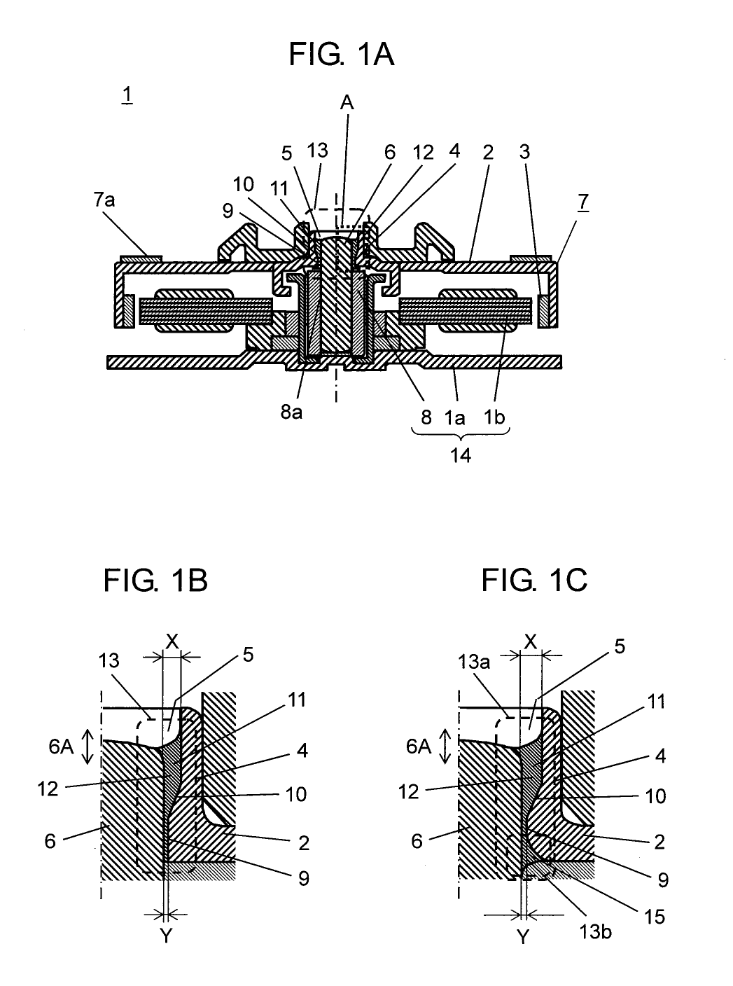

FIGS. 1A to 1C are schematic sectional views of a disc driving device according to a first exemplary embodiment of the present invention. FIG. 1A is a sectional view of disc driving device 1 including a rotor assembly in which adhesive fastening has been completed. FIG. 1B is an enlarged sectional view of a part “A”, which is the adhesive fastening portion shown in FIG. 1A. FIG. 1C is an enlarged sectional view of a modified example of the part “A” as the adhesive fastening portion shown in FIG. 1A.

As shown in FIG. 1A, disc driving device 1 of the first exemplary embodiment of the present invention includes rotor assembly 7 and bearing 8 for supporting rotor assembly 7. Rotor assembly 7 includes cylindrical rotor frame 2, magnet 3 arranged inside rotor frame 2 concentrically therewith, and shaft 6 to which rotor frame 2 is fixed. Shaft 6 is fixed at one end thereof with center hole 5 of shaft holder 4 formed at the rotation center of rotor frame 2. Center hole 5 of shaft holder 4 includes small-diameter portion 9 and inclined portion 10. Small-diameter portion 9 is formed at the bottom of center hole 5 in the axial direction of shaft 6. Inclined portion 10 is formed above small-diameter portion 9 in such a manner as to be tapered and expanded upward in the axial direction.

There is formed, between shaft holder 4 and shaft 6, void 11 which is filled with ultraviolet curing adhesive 12. Ultraviolet curing adhesive 12 can be, for example, transparent liquid and is cured when exposed to ultraviolet light, thereby adhesively fastening shaft holder 4 and shaft 6. As a result, adhesive fastening portion 13 is formed in the dotted region shown in FIG. 1A.

As shown in FIG. 1A, disc driving device 1 includes stator assembly 14 having bearing hole 8a into which shaft 6 is inserted. Stator assembly 14 includes bearing 8, stator core 1b, and base 1a for mounting them. Bearing 8 is formed at the center of the top surface of base 1a, and is provided at its center with the hole into which to insert shaft 6. Stator core 1b has salient poles, which are arranged on the top surface of base 1a at regular intervals in such a manner as to face magnet 3 inside rotor frame 2 and to be concentric with the periphery of bearing 8. Magnet 3 faces these salient poles so as to form a cylindrical space. The salient poles of stator core 1b have stator windings (not shown) wound therearound.

With this structure, ultraviolet curing adhesive 12 injected between center hole 5 of shaft holder 4 of rotor frame 2 and shaft 6 can be cured securely by a short-time UV irradiation due to the unique shape of adhesive fastening portion 13 in center hole 5. Ultraviolet curing adhesive 12 can also be cured in the state where shaft 6 is fixed to an accurately manufactured jig. This allows accurate control of the vertical angle of shaft 6 from the horizontal plane and the levelness of rotor frame 2, and hence, accurate assembly. It is also possible to perform a heating treatment in order to reduce the stress applied to shaft 6 or other components during the assembly using such a jig, and to increase the adhesive strength of ultraviolet curing adhesive 12. As a result, disc driving device 1 can have reliable fastening strength.

As described above, the unique shape of adhesive fastening portion 13 allows an adequate amount of ultraviolet curing adhesive 12 to be filled into void 11 between shaft 6 and center hole 5 of shaft holder 4 without causing air bubbles or uninjected portions. This increases the adhesive area between ultraviolet curing adhesive 12 and each of center hole 5 and shaft 6 so as to prevent the occurrence of air bubbles or uninjected portions, allowing adhesive fastening portion 13 to have sufficient fastening strength.

FIG. 1B is an enlarged sectional view of the part “A”, which is an essential part of adhesive fastening portion 13 that is in a dotted line region shown in FIG. 1A. The following is a detailed description, with reference to FIG. 1B, of adhesive fastening portion 13.

As shown in FIG. 1B, center hole 5 of shaft holder 4 includes small-diameter portion 9 at the bottom of void 11 in the axial direction 6A of shaft 6. Small-diameter portion 9 has a smaller inner diameter than the upper part of void 11. Center hole 5 also includes inclined portion 10, which is formed above small-diameter portion 9 in such a manner as to be tapered and expanded upward in the axial direction 6A. Void 11 formed between shaft holder 4 and shaft 6 is filled with ultraviolet curing adhesive 12, thereby forming adhesive fastening portion 13. Inclined portion 10 formed above small-diameter portion 9 and expanded upward in center hole 5 makes it easy to apply UV light from above to ultraviolet curing adhesive 12 injected in void 11 so as to cure it in a short time. The UV light from above is applied to the whole part of ultraviolet curing adhesive 12 injected in void 11. Thus, ultraviolet curing adhesive 12 is injected into inclined portion 10 which is tapered and expanded upward in the axial direction in adhesive fastening portion 13, so that UV irradiation can be applied to the region from the upper opening of inclined portion 10 to small-diameter portion 9 at the back. Shaft 6 and the inner wall surface of center hole 5 of rotor frame 2 have a clearance X therebetween at the upper end of void 11 and a clearance Y therebetween at the lower part of void 11.

FIG. 1C is an enlarged sectional view of a modified example of the part “A”, which is adhesive fastening portion 13 shown in FIG. 1A. In FIG. 1C, center hole 5 includes lower void 15 between shaft holder 4 and shaft 6 under small-diameter portion 9 in the axial direction 6A in addition to the structure of adhesive fastening portion 13 shown in FIG. 1B. The clearance at lower void 15 is larger than the clearance at small-diameter portion 9. Lower void 15 is filled with ultraviolet curing adhesive 12 to form strength reinforcing portion 13b. Strength reinforcing portion 13b is included in adhesive fastening portion 13a shown in FIG. 1C.

This structure enhances the adhesive fastening force between shaft holder 4 and shaft 6, and the reliability of the bond strength of adhesive fastening portions 13 and 13a.

When the clearance X at the upper end of void 11 is large as shown in FIGS. 1B and 1C, ultraviolet light such as UV light can reach deeply into the lower back of void 11, thereby accelerating the curing of ultraviolet curing adhesive 12. The large clearance X, however, requires a large amount of ultraviolet curing adhesive 12, causing the adhesive to be unevenly shrunk when cured. Such unevenness can cause an increase in the surface runout of rotor frame 2 or a decrease in the shear strength of ultraviolet curing adhesive 12 with respect to the inner surface of center hole 5 of shaft holder 4 or the surface of shaft 6.

When the clearance X is small, on the other hand, it is necessary to wait until ultraviolet curing adhesive 12 reaches the bottom of void 11, thus increasing the processing time. Furthermore, the insufficiency of the amount and the penetration depth of ultraviolet light into void 11 increases the uncured portion of ultraviolet curing adhesive 12. These disadvantageous conditions can cause an increase in the surface runout of rotor frame 2 or a decrease in the adhesion reliability of ultraviolet curing adhesive 12.

To avoid such a consequence, it is preferable to determine the preferred range of the clearance X. Different rotor assemblies 7 of disc driving device 1 according to the first exemplary embodiment have been produced changing the value of clearance X at the upper end of void 11 to 10 μm, 15 μm, 20 μm, and 50 μm, and their surface runout and fastening strength have been measured.

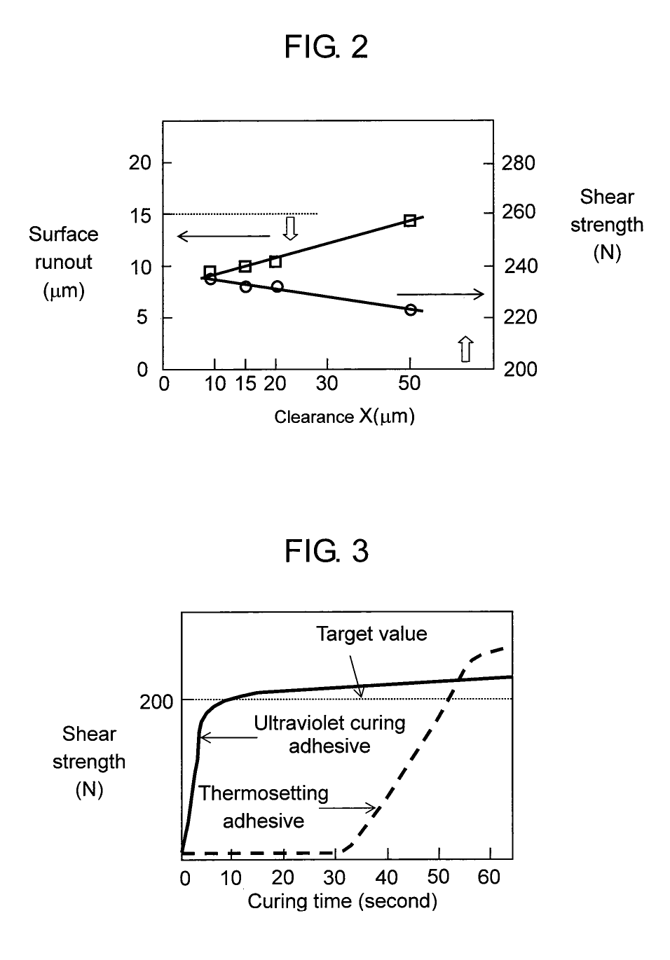

FIG. 2 shows the relationship between surface runout and shear strength as fastening strength with respect to the clearance X. The target values of the surface runout and the shear strength are 15 μm or less, and 200 N or more, respectively. In view of the mass production margin, the surface runout is preferably 10.5 μm or less, and the shear strength is preferably 230 N or more. From the relationship between surface runout and shear strength with respect to the clearance X shown in FIG. 2, the clearance X is preferably in the range of 10 to 20 μm in view of the mass production margin, and more preferably in the range of 12 to 18 μm in view of its value margin.

FIG. 3 shows the relationship between the time required for ultraviolet curing adhesive 12 to be cured by ultraviolet irradiation and shear strength. In this case, rotor assembly 7 has a clearance X of 50 μm. FIG. 3 also shows, for reference, the relationship between the time required for curing adhesive and shear strength when rotor assembly 7 having a clearance X of 50 μm is assembled using thermosetting adhesive.

FIG. 3 indicates that in order to obtain a bond strength corresponding to a shear strength of 200 N or more, when heat cured at 90° C., the thermosetting adhesive takes 50 seconds or more, and ultraviolet curing adhesive 12 takes only 15 seconds. This means that ultraviolet curing adhesive 12 can be cured in 30% or less of the time required for the thermosetting adhesive, increasing the productivity in an inline process. In order to enhance the adhesive fastening force, ultraviolet curing adhesive 12 is cured by two steps: a primary curing step using ultraviolet irradiation and a secondary curing step using heating. The primary curing step is performed by an inline process, and the secondary curing step is performed by a batch process. The primary curing step is completed in a very short time, having high productivity in mass production.

As described above, the upper end clearance in the void between the upper end of the shaft and the shaft holder can be set in the range of 12 to 18 μm so that the disc driving device can include the rotor assembly having accurately reduced surface runout and high shear strength of the adhesive fastening portion.

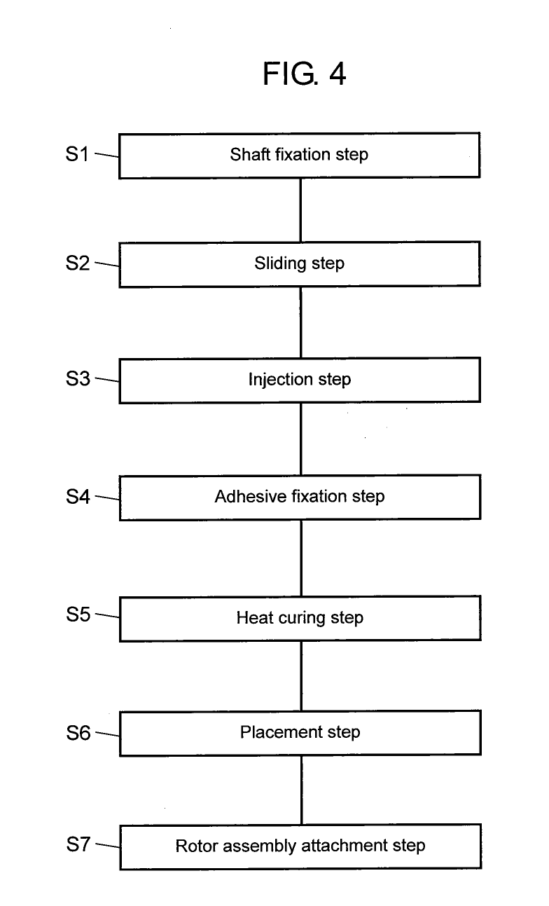

A process flow for manufacturing disc driving device 1 of the first exemplary embodiment of the present invention will be described as follows with reference to FIG. 4.

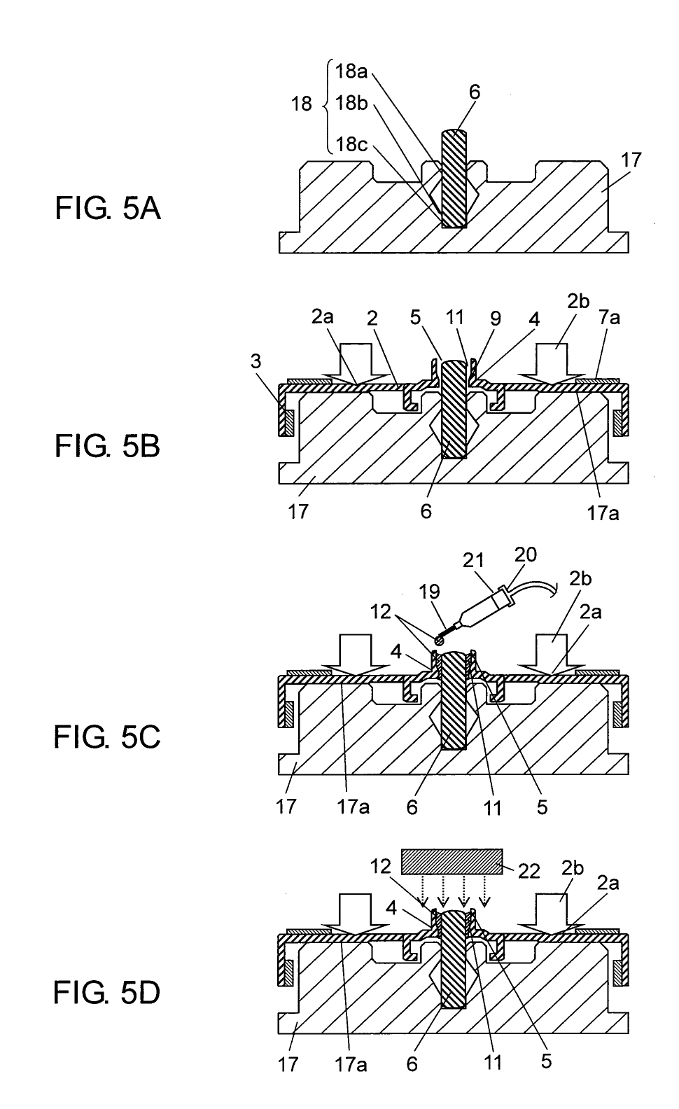

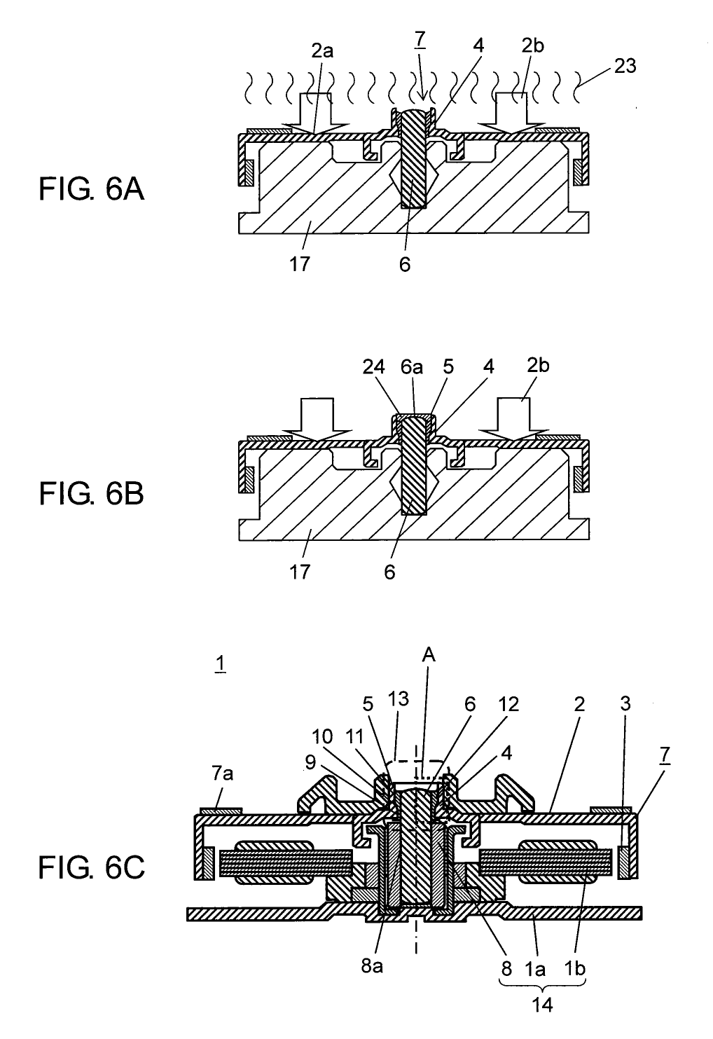

A method for manufacturing disc driving device 1 of the first exemplary embodiment will be described with reference to the sectional views of FIGS. 5A to 5D (the first half of the process flow), and FIGS. 6A to 6C (the second half of the process flow).

The method for manufacturing disc driving device 1 of the first exemplary embodiment includes a shaft fixation step S1, a sliding step S2, an injection step S3, an adhesive fixation step S4, a heat curing step S5, a placement step S6, and a rotor assembly attachment step S7. According to this method, after the injection step S3, a predetermined time is waited until ultraviolet curing adhesive 12 is completely injected into small-diameter portion 9 formed in center hole 5 of shaft holder 4, and lower void 15 formed under small-diameter portion 9. After waiting for the predetermined time, the adhesive fixation step S4 is performed.

FIG. 5A shows the shaft fixation step S1. In the shaft fixation step S1, shaft 6 is fixed in such a manner that its lower end is in contact with bottom-surface-of-shaft-fixing-section 18c of shaft fixing section 18 of rotor assembly jig 17. Shaft 6 is fixed by shaft fixing section 18, which includes shaft-upper-part position control section 18a and shaft-lower-part position control section 18b in rotor assembly jig 17.

FIG. 5B shows the sliding step S2. In the sliding step S2, center hole 5 of shaft holder 4 formed at the rotation center of cylindrical rotor frame 2 is slid onto shaft 6 using rotor assembly jig 17. As a result, rotor frame 2 is slid vertically onto shaft 6. Rotor assembly jig 17 is a useful jig to vertically slid rotor frame 2 onto shaft 6. In this case, rotor frame 2 holds magnet 3, and is mounted with turntable 7a on the top of its disc portion. Magnet 3 is arranged inside the cylindrical part of rotor frame 2 concentrically therewith and forms a cylindrical space. Rotor frame 2 is provided at its center with shaft holder 4 having center hole 5 into which shaft 6 is inserted and which includes small-diameter portion 9 at its bottom. Rotor frame 2 is slid onto shaft 6 mounted on rotor frame mounting surface 17a. In this case, rotor frame 2 is pressed from top-surface-of-rotor-frame 2a in the direction of an arrow 2b and kept in a state in which the center line of shaft 6 and top-surface-of-rotor-frame 2a are vertical to each other.

FIG. 5C shows the injection step S3. In the injection step S3, ultraviolet curing adhesive 12 is injected from above into void 11 between shaft holder 4 and shaft 6. Ultraviolet curing adhesive 12 is injected by syringe 21. Syringe 21 has nozzle 19 and is connected to connector 20 via a tube connected to a controller (not shown) of a dispenser. Syringe 21 includes the dispenser containing ultraviolet curing adhesive 12. A predetermined amount of ultraviolet curing adhesive 12 is discharged from the tip of nozzle 19 by applying pressure to the surface of liquid resin in syringe 21 by air or inert gas. The amount of ultraviolet curing adhesive 12 to be discharged is controlled by setting the time and the value of the pressure using the controller. After the injection step S3, the predetermined time is waited until ultraviolet curing adhesive 12 is completely injected into small-diameter portion 9 and inclined portion 10 formed in center hole 5 of shaft holder 4, or further into lower void 15 when it is formed under small-diameter portion 9. After waiting for the predetermined time, the adhesive fixation step S4 described below is performed. Ultraviolet curing adhesive 12 may be epoxy-based liquid resin, acrylic-based liquid resin, polyimide-based liquid resin, or polybenzoxazole-based liquid resin.

It is alternatively possible to insert shaft 6 vertically into rotor frame 2 after ultraviolet curing adhesive 12 is applied to the inner circumference surface of shaft holder 4 of rotor frame 2. According to this approach, when shaft 6 is inserted into rotor frame 2, ultraviolet curing adhesive 12 is pushed aside, causing the position of its liquid level to be raised greatly in the axial direction in void 11 between shaft holder 4 and shaft 6. This makes it a little harder to control the amount of ultraviolet curing adhesive 12 to be applied, but has an advantage of facilitating the application of ultraviolet curing adhesive 12 all over the inner circumference surface of shaft holder 4. Thus, it is possible to reverse the order of the sliding step S2 and the injection step S3 in the method for manufacturing the disc driving device of the first exemplary embodiment.

FIG. 5D shows the adhesive fixation step S4. In the adhesive fixation step S4, ultraviolet light is applied from above void 11 to ultraviolet curing adhesive 12 so as to adhesively fix rotor frame 2 to shaft 6. The adhesive fixation step S4 corresponds to the primary curing step. As a method for applying the primary curing to ultraviolet curing adhesive 12 injected in void 11, as shown in FIG. 5D, void 11 containing ultraviolet curing adhesive 12 instilled therein is placed under ultraviolet irradiation head 22, which is, for example, an ultra-high-pressure mercury lamp. Thus, a predetermined amount of ultraviolet light is applied for a predetermined time so that transparent liquid ultraviolet curing adhesive 12 goes through the primary curing. The primary curing adhesively fastens shaft 6 and shaft holder 4 held by rotor assembly jig 17 in such a manner that the surface of turntable 7a of rotor frame 2 can be vertical with the center line of shaft 6.

FIG. 6A shows the heat curing step S5. In the heat curing step S5, ultraviolet curing adhesive 12 injected in void 11 is heat cured in a heating device (not shown). The heat curing step S5 corresponds to the secondary curing step. After ultraviolet curing adhesive 12 go through the primary curing, a plurality of rotor assemblies 7 of a plurality of disc driving devices 1 are housed together in heating atmosphere 23 in a furnace whose inside temperature is set at, for example, 90° C., and heated for a predetermined time. This heating treatment increases the bond strength between ultraviolet curing adhesive 12 and each of shaft holder 4 and shaft 6. The heating treatment also allows ultraviolet curing adhesive 12 made of a resin material to increase the crosslink density of the resin part that has not been cross-linked by the primary curing using the light reaction, and hence, to increase its cured product strength.

FIG. 6B shows the placement step S6. In the placement step S6, lid 24 is placed on the top of shaft 6. In the placement step S6, first, ultraviolet curing adhesive 12 is instilled to upper end surface 6a of shaft 6 of rotor assembly 7 that has been through the primary curing. Then, lid 24 is fitted into center hole 5 of shaft holder 4 until the bottom surface of lid 24 comes into contact with upper end surface 6a of shaft 6.

FIG. 6C shows the rotor assembly attachment step S7. In the rotor assembly attachment step S7, rotor assembly 7 is attached to bearing 8 of stator assembly 14. In the rotor assembly attachment step S7, first, rotor assembly 7 including rotor frame 2 adhesively fastened to shaft 6 is removed from rotor assembly jig 17. Then, shaft 6 of rotor assembly 7 is inserted into bearing hole 8a of stator assembly 14 including bearing 8.

By performing the above-described steps, disc driving device 1 of the first exemplary embodiment is completed. This method for manufacturing disc driving device 1 allows rotor frame 2 to be adhesively fastened vertically to shaft 6 with high accuracy. This achieves disc driving device 1 including rotor assembly 7 whose surface runout is reproducibly reduced to 10 μm or less.

Ultraviolet curing adhesive 12 injected between center hole 5 of shaft holder 4 of rotor frame 2 and shaft 6 can be cured securely and productively by a short-time UV irradiation due to the unique shape of adhesive fastening portion 13 of center hole 5. Ultraviolet curing adhesive 12 can also be cured in the state where shaft 6 is fixed to an accurately manufactured rotor assembly jig 17. This allows accurate control of the vertical angle of shaft 6 from the horizontal plane and the levelness of rotor frame 2, and hence, accurate assembly.

It is also possible to perform the heat curing step S5 in order to reduce the stress applied to shaft 6 or other components during the assembly using such a jig, and to increase the strength of ultraviolet curing adhesive 12. As a result, disc driving device 1 can have reliable fastening strength.

When rotor assembly 7 is processed by inline, the primary curing of ultraviolet curing adhesive 12 is performed using ultraviolet curing technology. This allows the time required for curing the resin to be as low as 30% or less of the time required for curing the thermosetting resin. This increases productivity, and reduces production cost.

### Second Exemplary Embodiment

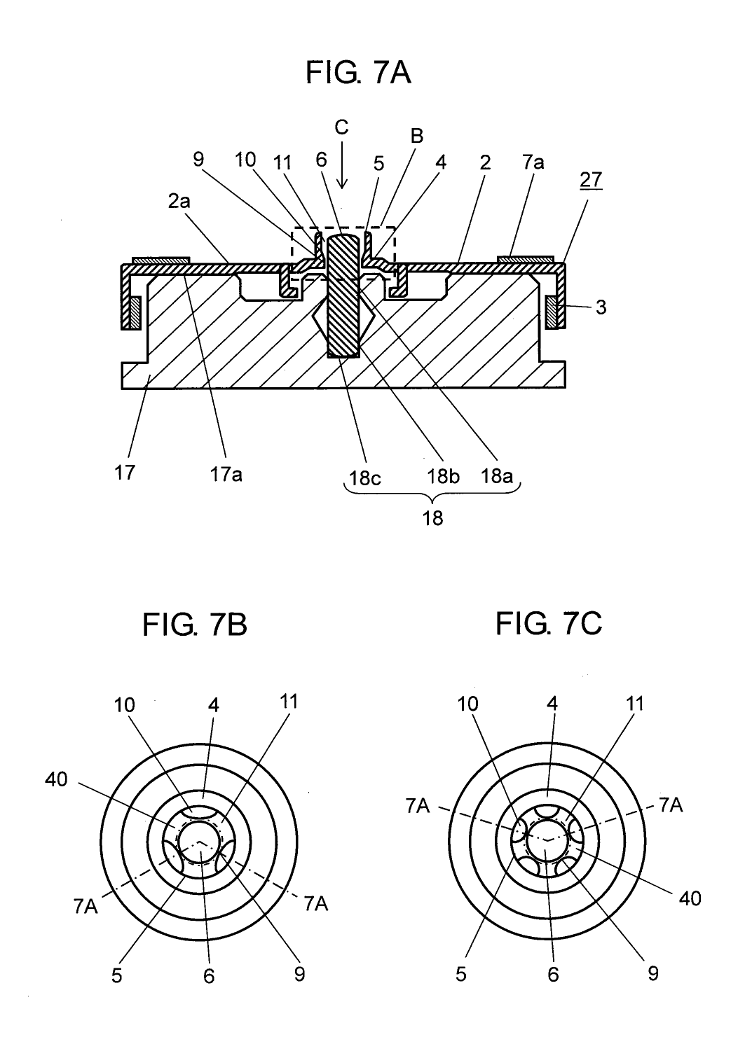

FIGS. 7A to 7C are schematic sectional views of rotor frame 2 of a disc driving device according to a second exemplary embodiment of the present invention. FIG. 7A is a sectional view of rotor assembly 27 mounted on rotor assembly jig 17. FIG. 7B is an enlarged plan view of an essential part of rotor assembly 27 that is in a dotted line region “B” shown in FIG. 7A when viewed from the direction of an arrow “C”. FIG. 7C is an enlarged plan view of a modified example of the essential part of rotor assembly 27 shown in FIG. 7A when viewed from the direction of the arrow “C”.

Rotor assembly 27 shown in FIG. 7A has the same cross sectional structure as rotor assembly 7 of the first exemplary embodiment. More specifically, center hole 5 includes small-diameter portion 9 at the bottom of center hole 5 in the axial direction of shaft 6, and inclined portion 10, which is formed above small-diameter portion 9 in such a manner as to be tapered and expanded upward in the axial direction. In order to make ultraviolet curing adhesive 12 reach the bottom of void 11, in the present exemplary embodiment, instead of forming inclined portion 10 on the whole inner circumference of center hole 5, inclined portions 10 are arranged at three positions at regular intervals as shown in FIG. 7B. In other words, in the region of center hole 5 other than the three positions, shaft holder 4 and shaft 6 vertically penetrate parallelly in the axial direction. Thus, in the present exemplary embodiment, center hole 5 includes, in addition to inclined portions 10, penetrating portions 40 which penetrate in such a manner that shaft holder 4 and shaft 6 have a predetermined interval therebetween. As shown in FIG. 7B, tapered inclined portions 10 and penetrating portions 40 are arranged alternately in the circumferential direction of center hole 5 so as to form void 11. In the present exemplary embodiment, void 11 thus formed is filled with the ultraviolet curing adhesive so as to form the adhesive fastening portion. In the present exemplary embodiment, center hole 5 of shaft holder 4 thus structured allows the ultraviolet curing adhesive to be injected into the distal end of center hole 5, and also allows the UV light to reach the ultraviolet curing adhesive injected in the distal end or the back of center hole 5.

As shown in FIG. 7C, inclined portions 10 may be arranged at five positions of center hole 5 at regular intervals, and its shape may be designed according to the size of center hole 5 or rotor frame 2, or the required adhesive fastening strength. As shown in FIGS. 7B and 7C, even when the shape of rotor assembly 27 is modified, the sectional view seen from line 7A-7A is the same as the sectional view of FIG. 7A.

With this structure, ultraviolet curing adhesive 12 can be injected into the bottom of void 11, and ultraviolet light can reach deeply into void 11. As a result, the adhesive fastening portion in which center hole 5 of shaft holder 4 and shaft 6 are adhesively fastened via the ultraviolet curing adhesive has higher strength and reliability of adhesive fastening, while reducing the surface runout of turntable 7a within a target value.

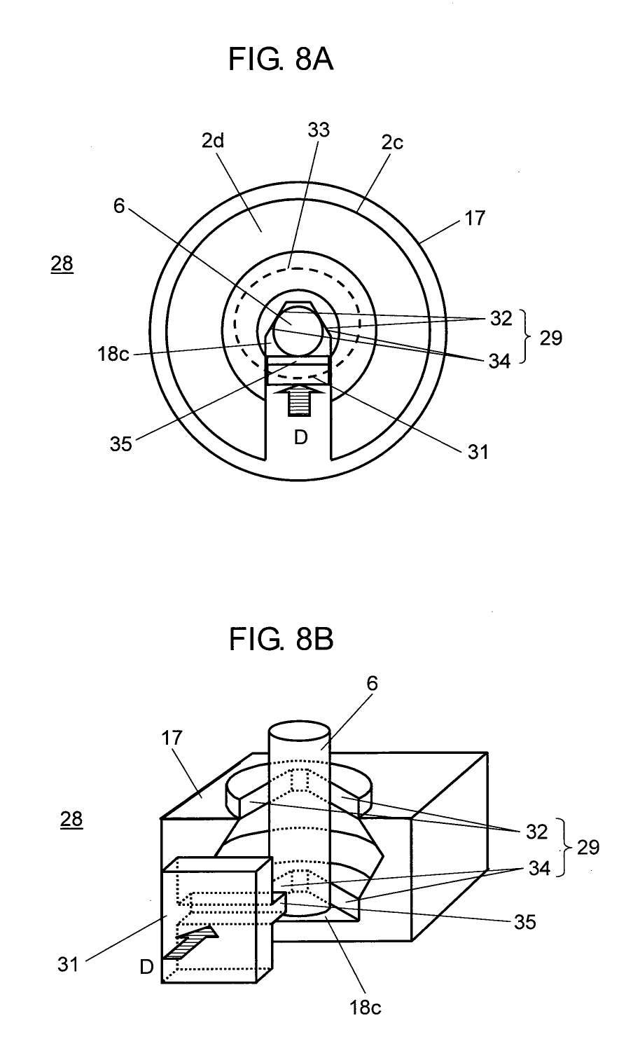

FIGS. 8A and 8B are schematic views of an assembly jig which can be used to assemble rotor assemblies 7 and 27 in the first and second exemplary embodiments of the present invention. FIG. 8A is a plan view of rotor assembly jig 17. FIG. 8B is a perspective view of an essential part of shaft fixing section 29 at the center of rotor assembly jig 17.

As shown FIGS. 8A and 8B, assembly jig 28 is formed of rotor assembly jig 17 and shaft-center-part position control jig 31. Rotor assembly jig 17 includes shaft fixing section 29 formed at its center, rotor frame mounting portion 2c formed at its periphery, and notch groove 33. Notch groove 33 is formed to fix shaft-center-part position control jig 31 after it is slid to a predetermined position in the direction of an arrow “D”. More specifically, V-shaped notch groove 33 forms two faces of a triangular prism which are vertical to rotor frame mounting surface 2d. Notch groove 33 extends from bottom-surface-of-shaft-fixing-section 18c to the upper surface of rotor assembly jig 17 at the center of shaft fixing section 29.

Notch groove 33 (hereinafter, “guide groove 33”) is cut in the middle in the height direction. As a result, as shown in FIG. 8B, rotor assembly jig 17 includes two holding faces of shaft-upper-part position control section 32, and two holding faces of shaft-lower-part position control section 34, which is formed upward from bottom-surface-of-shaft-fixing-section 18c.

Rotor frame mounting surface 2d is formed as an accurate horizontal plane having a predetermined height from bottom-surface-of-shaft-fixing-section 18c. Shaft-center-part position control jig 31 is provided at the middle of its height with shaft-center-part position control section 35 which slides in the direction of the arrow “D” toward the center of shaft fixing section 29. In other words, shaft-center-part position control section 35 of shaft-center-part position control jig 31 is formed between shaft-upper-part position control section 32 of shaft fixing section 29 and shaft-lower-part position control section 34.

Therefore, in order to fix shaft 6 to rotor assembly jig 17, the above-mentioned assembly jig 28 is prepared. Then, shaft 6 is disposed in such a manner that one of its side surfaces comes into contact with shaft-upper-part position control section 32 and shaft-lower-part position control section 34 of rotor assembly jig 17. Shaft-upper-part position control section 32 and shaft-lower-part position control section 34 position-control the upper and lower parts of the outer peripheral surfaces of shaft 6 each by two faces. Furthermore, shaft 6 is disposed in such a manner that its lower end surface comes into contact with bottom-surface-of-shaft-fixing-section 18c. Then, shaft 6 is held in the state of being pressed against shaft-center-part position control section 35 of shaft-center-part position control jig 31 along guide groove 33.

Thus, shaft holder 4 formed at the rotation center of rotor frame 2 holds the upper and lower parts of shaft 6 by the two of the three faces of the triangular prism which circumscribes cylindrical shaft 6. Shaft holder 4 also holds the center of shaft 6 by the remaining one of the three faces of the triangular prism. After shaft 6 is thus held, the sliding step S2 described in the exemplary embodiment is performed.

This method allows further accurate control of the vertical angle of shaft 6 from the horizontal plane and the levelness of rotor frame 2, and hence more accurate assembly.

When structured and manufactured as described above, the disc driving device of the present invention has, in spite of its small size, an extremely low surface runout of its rotor frame mounting surface, and high adhesion reliability of the adhesive fastening portion in which the shaft holder of the rotor frame and the shaft are adhesively fastened.

### INDUSTRIAL APPLICABILITY

According to the disc driving device of the present invention, the surface runout of the turntable including the rotor frame is accurately reduced, and the adhesive fastening portion between the rotor frame and the shaft is reliable and formed productively by a short-time UV irradiation due to its unique shape. Furthermore, the adhesive can be cured in the state where the shaft is fixed to an accurately manufactured jig. This provides a method for manufacturing a disc driving device which ensures accurate assembly by accurately controlling the vertical angle of the shaft from the horizontal plane and the levelness of the rotor frame. The method is particularly useful in personal portable devices which have increasingly used disc driving devices in recent years.

1. A disc driving device comprising:
a rotor assembly including:
a cylindrical rotor frame;
a magnet arranged inside the rotor frame concentrically therewith;
a shaft fixed at one end thereof with a center hole of a shaft holder formed at a rotation center of the rotor frame; and
a bearing for supporting the rotor assembly, wherein
the center hole of the shaft holder includes a small-diameter portion at a bottom thereof in an axial direction of the shaft, and an inclined portion above the small-diameter portion, the inclined portion being tapered and expanded upward in the axial direction, and
the shaft holder and the shaft have a void therebetween, the void being filled with ultraviolet curing adhesive so as to form an adhesive fastening portion.

2. The disc driving device of claim 1, wherein
the center hole further includes a lower void under the small-diameter portion in the axial direction, the lower void being formed between the shaft holder and the shaft, and filled with the ultraviolet curing adhesive so as to form a strength reinforcing portion.

3. The disc driving device of claim 1, wherein
the void has an upper end clearance between an upper end of the shaft and the shaft holder, the upper end clearance being in a range of 12 μm to 18 μm.

4. The disc driving device of claim 1, wherein
the center hole further includes penetrating portions penetrating in such a manner that the shaft holder and the shaft have a predetermined interval therebetween,
the tapered inclined portions and the penetrating portions are arranged alternately in a circumferential direction of the center hole so as to form the void including the inclined portions and the penetrating portions, and
the void is filled with the ultraviolet curing adhesive so as to form the adhesive fastening portion.

5. A method for manufacturing a disc driving device comprising:
fixing a shaft in such a manner that a lower end of the shaft comes into contact with a bottom-surface-of-shaft-fixing-section of a shaft fixing section of a rotor assembly jig;
sliding a center hole of a shaft holder formed at a rotation center of a cylindrical rotor frame onto the shaft, thereby vertically sliding the rotor frame onto the shaft;
injecting ultraviolet curing adhesive from above into a void formed between the shaft holder and the shaft;
adhesively fixing the rotor frame to the shaft by applying ultraviolet light from above the void, thereby curing the ultraviolet curing adhesive;
heat curing the ultraviolet curing adhesive injected in the void between the shaft holder and the shaft in a heating device;
placing a lid on a top of the shaft; and
attaching a rotor assembly to a bearing of a stator assembly, wherein
after the injecting step and before the adhesively fixing step, a predetermined time is waited until the ultraviolet curing adhesive is completely injected into a small-diameter portion formed in the center hole of the shaft holder and an inclined portion formed above the small-diameter portion in such a manner as to be tapered and expanded upward in an axial direction.

6. The method for manufacturing a disc driving device of claim 5, wherein
the sliding step is performed after the shaft holder holds an upper part and a lower part of the shaft each by two of three faces of a triangular prism circumscribing the cylindrical shaft, and then holds a center of the shaft by a remaining one of the three faces of the triangular prism.

7. The disc driving device of claim 2, wherein
the void has an upper end clearance between an upper end of the shaft and the shaft holder, the upper end clearance being in a range of 12 μm to 18 μm.
